(19) United States
(12) Patent Application Publication
(10) Pub. No.: US 2010/0038896 A1
(43) Pub. Date: Feb. 18, 2010

(54) Varied sequence book

(76) Inventor: Alan J. Weiss, East Greenwich, RI (US)

Correspondence Address: Richard D. Zimmerman;Chace Ruttenberg & Freedman, LLP, Suite 300, One Park Row, Providence, RI, 02903, US

(21) Appl. No.: 12/583,150

(22) Filed: Aug. 14, 2009

Related U.S. Application Data
(60) Provisional application No. 61/189,176, filed on Aug. 15, 2008.

(51) Int. Cl. B42F 21/00

(52) U.S. Cl. 283/38

(57) ABSTRACT

This invention is a book with chapters out of sequence so the story end is not foreshadowed. A referral notation at the end of each chapter will direct the reader to the page at which the next chapter begins. By rearranging the chapters, the reader is more likely to be surprised by the conclusion.

### PRIORITY CLAIM

Applicant claims priority based on U.S. Provisional Application Ser. No. 61/189,176, filed Aug. 15, 2008, titled “Varied Sequence Book” by inventor Alan J. Weiss.

### FIELD OF INVENTION

This invention concerns books.

### BACKGROUND

Known novels and other books are presented in a customary sequence in which the book user can read the book starting at the physical beginning of the book and reading to the physical end of the book without skipping pages. This is customary because it allows the user to read the story in sequence from beginning to end without skipping text to go forward or backwards in the text. For some books, such as mysteries or works of fiction, however, this presentation has the disadvantage of foreshadowing the end of the story. The reader can see the number of pages remaining in the book and know when the conclusion of the book is near. The customary sequence also can indirectly reveal to the user that a particularly exciting or active passage is or is not the climax or resolution of the book, depending on how near to the end of the book the passage is.

What is needed is a book that changes the sequence of the book so that the end of the book is not readily apparent by the amount of the book remaining.

What is needed is a book that changes the sequence of the book so the reader enjoys the book because exciting or interesting passages are not indirectly revealed as conclusions or resolutions.

### SUMMARY OF INVENTION

This invention is a book with segments, such as chapters, out of the customary sequence so the story end is not foreshadowed. Book segment locations are identified by sequence identifiers, such as page numbers or chapter numbers. A referral notation, preferably at the end of each book segment, will direct the user to the next book segment to read. By rearranging the book segments, the user is more likely to be surprised by the conclusion.

### DETAILED DESCRIPTION OF THE PREFERRED EMBODIMENT

The varied sequence book comprises book segments, segment locations, segment location identifiers and referral notations.

The book segments are portions or fragments of the book. Book segments are constituent parts into which the book is divided. Book segments ordinarily will be chapters of the book, but may be any other portion or fragment into which the book is divided. Some books, such as short books, and simple children's books, may have book segments comprised of a single page. Long, large, complicated or similar single pages, such as a computer screen, could be divided into book segments, so that one page contains multiple book segments.

Segment location refers to the position, site, place or spot of the book segment within the book. In known books, segments are physically located in the order in which the user is intended to read the segment.

Segment location identifiers are the numbers, names, characters, symbols, colors, or other visual or auditory forms of communication used to identify book segment locations. Segment location identifiers preferably are the page numbers of the book on which respective book segments begin. Alternative segment location identifiers could be chapter numbers, names or colors. The specific segment location in a book to which a segment location identifier refers preferably can be located easily by the book user, such as by using a page number.

Referral notations are words, numbers, names, characters, symbols, colors, or other visual or auditory forms of communication used to communicate segment location identifiers to the book user. A book segment will include a referral notation to direct the book user to the next book segment. Preferably the end of a book segment will include a referral notation, such as “The next chapter begins on page 132” to refer the book user to the segment intended to be read next.

The “book user” or “user” refers to any person, entity or machine that reads the book or otherwise employs the book to learn information in the book. The “story” refers to the story, message, meaning or other information presented in the book. “Text” refers to numbers, names, characters, symbols, colors, or other visual or auditory forms of communication used to communicate the story. In most cases, the user will read the book to learn a story presented in the book. A book could contain only pictures or symbols, and in such cases, the user would be a user of the book as that term is used in this specification.

“Reading” and “read” means to receive or take in the meaning of the text, or to learn what one has viewed in the text. These terms include the common meanings of the words to read a book.

A book has a physical beginning and a physical end. Physical beginning refers to the location of the media, such as pages, the user customarily first encounters in reading the text. Books also have a story beginning, which is the text that the story's author intends the reader to first read. In customary books, the story beginning is located at the physical beginning, such as on the page inside the front cover of the book. (A title page, and sometimes a cover and blank pages, usually precedes the physical beginning in known books and may do so in this invention.) Similarly, the physical end of a book is the location of the media, such as paper pages, the user last encounters in reading the text.

As stated, in known books, the physical beginning and story beginning are located in the same physical location, such as the inside the front cover or title page. The physical end and the story end also are located in the same physical location, usually inside the back cover. The user can read the story sequence in the same sequence as the physical media of the book, without having to omit pages in the physical sequence of the book, and without having to go back towards the physical beginning once having passed some portion of the physical book in the sequence from physical beginning to physical end.

In some cultures, a book is read from what is viewed in western cultures as the back cover of the book. Books in such cultures, nevertheless, are still read from physical beginning to physical end. The physical beginning and physical end are merely reversed from the western user's perspective.

Unlike known books, in which the story is read from physical beginning to physical end, in the present invention, the sequence is varied so that the user will read the story out of the customary physical beginning to physical end sequence. The varied sequence will make it more difficult for the user to determine what fraction of the book has been read, and what fraction of the book remains.

The elements of a varied sequence book can be understood by comparison to known books. Known books have book segments, segment locations, and usually segment location identifiers, but no referral notations. Chapters typically are known book segments. Chapters and pages of known books typically are numbered, providing segment location identifiers. The segment locations in known books, as discussed above, are dictated by the sequence of the story. As discussed above, authors place segments in known books in segment locations so the user can go from the physical beginning of the book to the physical end without having to skip book segments to go physically forward or back in the book. For example, in a known book with five chapters and pages numbered one through one hundred, chapters one through five could be located in order of one through five, with chapter one beginning on page one, chapters two, three, four and five beginning on pages 20, 40, 60 and 80 respectively. Chapter numbers and page numbers in known books allow the user to locate where they were reading in the book when they interrupted the reading, and to return to that location. They also may give the user a sense of accomplishment, but are not used to direct the user to a new portion of the book.

In a varied sequence book, for example, having five chapters (segments), with segment locations determined arbitrarily or randomly, the book segments could be placed, from the physical beginning to the physical end of the book, so that the user would first encounter chapter one, then chapter five, then chapters three, two and four. Chapter one could be stated on page one. At the end of chapter one, a referral notation would direct the user to the page on which chapter two begins, with a referral notation such as “Chapter 2 begins on page 60.” Referral notations at the end of chapter two, three and four would refer the user to the beginning of the next chapter, chapters three, four and five respectively, which could begin on pages 40, 80 and 20 respectively. This is an example, and the sequence and beginning page numbers and book segment lengths could, and likely would vary from book to book.

The varied sequence book could use chapter numbers, but in books with few chapters, chapter numbers could foreshadow a climax, conclusion or the relevant importance of rising action. In such cases, it is preferable that the chapters not be numbered, and segment location identifiers be page numbers.

Additionally, the varied sequence book would not need to begin with chapter one at the physical beginning of the book. The inside book cover, or first page, could include a referral notation stating “Go to page X to begin this book”, where “X” refers to an arbitrarily or randomly selected segment location identifier.

Some books, such as children's books and books with few book segments could use colors for segment location identifiers. Referral notations, for example, could read “Go to Blue”, where “Blue” is a printed word, and could be printed in the color blue. Alternatively, the referral notation could read “Go to X”, where “X” is a shape or figure or other symbol colored blue. Tabs, markers on the book, or the pages themselves, could be printed in blue to serve as segment location identifiers. Obviously, using the color blue is an example, and other colors or symbols could be used.

Although the present invention has been described in terms of certain preferred embodiments, other embodiments will become apparent to those of skill in the art with reference to the disclosure contained herein. Accordingly, the scope of the present invention is intended not to be limited by the disclosed embodiments, but to be coextensive with the full scope of the attached claims.

I claim:

1. A varied sequence book comprising:
a plurality of book segments, at least one segment location identifier, at least one referral notation, where at least one of the book segments is out of the customary sequence for known books, and a referral notation refers the user to each book segment out of the customary sequence by referring to a segment location identifier.

2. The varied sequence book of claim 1 where each segment location identifier is selected from the group consisting of a page number, a page letter, a chapter number, a chapter letter, a name and a color.

3. The varied sequence book of claim 2 where each referral notation includes a symbol selected from the group consisting of a page number, a page letter, a chapter number, a chapter letter, a name and a color.

4. The varied sequence book of claim 1 having text, in which the text is displayed on pages or a computer screen.

5. A varied sequence book comprising:
a story presented on physical media;
a physical beginning, a story beginning, a physical end, a story end, a plurality of book segments, at least one segment location identifier and at least one referral notation, where the book segments are located so that the user cannot read the story from story beginning to story end by viewing physical media in sequence from physical beginning to physical end, because book segments are out of sequence, and where a referral notation refers the user to a segment location identifier for each book segment out of sequence.

6. The varied sequence book of claim 5 where each segment location identifier is selected from the group consisting of a page number, a page letter, a chapter number, a chapter letter, a name and a color.

7. The varied sequence book of claim 6 where each referral notation includes a symbol selected from the group consisting of a page number, a page letter, a chapter number, a chapter letter, a name and a color.

8. A varied sequence book comprising:
a plurality of book segments, a segment location for each book segment, and at least one referral notation, where at least one book segment has a segment location identifier and is located in a segment location out of the customary sequence for known book segment locations, and a referral notation refers the user to a segment location identifier for the book segment out of the customary sequence.

9. The varied sequence book of claim 8 where each segment location identifier is selected from the group consisting of a page number, a page letter, a chapter number, a chapter letter, a name and a color.

10. The varied sequence book of claim 9 where each referral notation includes a symbol selected from the group consisting of a page number, a page letter, a chapter number, a chapter letter, a name and a color.
